(19) United States
(12) Patent Application Publication
(10) Pub. No.: US 2012/0018422 A1
(43) Pub. Date: Jan. 26, 2012

(54) METHOD AND APPARATUS FOR PRODUCING A STRUCTURAL PART USING INDUCTION HEATING

(75) Inventors: Friedrich Bohner, Oerlinghausen (DE); Jochen Dörr, Bad Driburg (DE); Jochem Grewe, Salzkotten (DE); Ulrich Huschen, Lichtenau (DE)

(73) Assignee: Benteler Automobiltechnik GmbH, Paderborn (DE)

(21) Appl. No.: 13/009,243

(22) Filed: Jan. 19, 2011

(30) Foreign Application Priority Data
Jan. 20, 2010 (DE) 102010005263.9-14

(51) Int. Cl. H05B 6/10; H05B 6/02

(52) U.S. Cl. 219/602

(57) ABSTRACT

A region of a structural part, which is made of a precipitation-hardened aluminum alloy, is inductively heated to a temperature between 100° C. and 300° C. for a maximum time period of one minute. After undergoing the heating process, the region of the structural part is mechanically shaped by a forming tool.

### CROSS-REFERENCES TO RELATED APPLICATIONS

This application claims the priority of German Patent Application, Serial No. 10 2010 005 263.9-14, filed Jan. 20, 2010, pursuant to 35 U.S.C. 119(a)-(d), the content of which is incorporated herein by reference in its entirety as if fully set forth herein.

### BACKGROUND OF THE INVENTION

The present invention relates to a method and apparatus for producing a structural part using induction heating.

The following discussion of related art is provided to assist the reader in understanding the advantages of the invention, and is not to be construed as an admission that this related art is prior art to this invention.

In general, malleable precipitation-hardened aluminum alloys in T6 condition (solution-annealed and artificially hardened) such as AlCuMg (2xxx), AlMgSi (6xxx) or AlZnMg[Cu] (7xxx) have a high strength which is accompanied however by little malleability. Alloys of this type are therefore difficult to shape at room temperature in the T6 condition. Cracks can form easily.

German patent document DE 196 20 196 relates to a process for shaping a flat metal workpiece, especially an aluminum sheet, in which the workpiece is heat-treated in a narrowly spatially limited shaped region. The heat treatment is applied by a radiation tool (laser beam or electron beam) along a line and the shaping is performed after the heat treatment. As heat is applied along a very narrow line and aluminum has good heat conductivity, the heated region cools down rapidly and is malleable to a certain extent.

It would be desirable and advantageous to address prior art shortcomings and to produce a structural part made from precipitation-hardened aluminum alloy in a simple and yet reliable manner, without encountering cracks and without deterioration in mechanical material strength.

### SUMMARY OF THE INVENTION

According to one aspect of the present invention, a method includes the steps of inductively heating a region of a structural part made of a precipitation-hardened aluminum alloy to a temperature between 100° C. and 300° C. for a maximum of 1 minute, and mechanically shaping the region.

The present invention resolves prior art problems by inductively heating the region that is intended to be shaped of the structural part to a temperature between 100° C. and 300° C. The localized heating of the region being shaped is executed only within a short period of maximal 1 minute. It has been found that a heating to an elevated temperature in a range of 100° C. to 300° C. for 1 minute improves malleability of hardened aluminum alloys. Material strength and breaking elongation or ductility are not adversely affected. It is thus advantageously possible within the scope of the invention to heat, for example, a localized region of an extruded profile with at least one longitudinal channel and then to provide the heated region with any configuration of an embossment. This measure may optionally be repeated successively in longitudinal direction of the extruded profile to provide the structural part with a plurality of embossments.

It is also advantageously possible to locally inductively heat inner, and optionally also outer, longitudinal walls of a structural part, i.e., for example an extruded profile with several longitudinal channels, so that these longitudinal walls may also, optionally, be shaped in a desired manner. This may be applicable for example for a bumper which can be locally embossed for attachment of a tow lug. Also targeted heating of lateral flanges of hollow profiles in particular is possible, e.g. bumpers, side rails, or crossbeams of motor vehicle bodies. Such flanges can thus be shaped in a desired manner without encountering any crack formation. Other components that can be worked on in accordance with the invention involve structural and/or safety elements in vehicle body construction, such as door impact carriers, A and B pillars.

According to another advantageous feature of the present invention, the heating step may be executed in pulsed mode. In this way, localized overheating is prevented. This is followed by a momentary on and off switching of the generator, causing heat produced by eddy current to flow off into colder regions before the region being shaped is again inductively heated.

According to another advantageous feature of the present invention, the region of the structural part can be heated by an induction coil. The induction coil may have a contour which is suited to a contour of the region of the structural part. As a result, the region of the structural part that is to be shaped is covered by the induction coil and heated by the introduced heat flow.

According to another advantageous feature of the present invention, the induction coil may have a ring-shaped configuration.

According to another advantageous feature of the present invention, the shaping step may be carried out by a forming die which is part of a forming tool and movable through the induction coil after termination of the heating process. In other words, the induction coil remains on the structural part. The desired geometry of the structural part can thus be directly shaped after the heating process. There is no need to transfer the structural part between an inductive heating station and a forming tool. As a result, the region being shaped is not excessively cooled when the shaping process begins because the time period for the heat flow into colder regions of the structural part is minimized.

As an alternative, the targeted region of the structural part can be locally shaped by a forming tool which can be moved towards the region of the structural part after the region underwent the heating step and the induction coil has been removed from the region of the heated structural part. In this way, there is no need to move the forming tool through the induction coil. The configuration of the induction coil can be best suited to the contour of the targeted region which is quickly to be heated and shaped.

According to another advantageous feature of the present invention, the induction coil may have a fork-shaped configuration. This configuration is especially applicable when the structural part has an inner longitudinal wall which is desired to be locally heated and shaped, in particular at the end thereof. The induction coil is then moved from the end face of the structural part while embracing the longitudinal wall, and withdrawn again in this direction after the longitudinal wall has been heated. Lateral flanges of a structural part may also be heated locally by means of a forked induction coil.

After shaping the region or regions of the structural part, the structural part can be transferred simultaneously or successively to undergo further shaping operations.

According to another aspect of the present invention, an apparatus includes a mounting to secure a structural part, an induction coil for placement on the structural part to heat a region of the structural part, and a forming tool movable in a direction transversely to the structural part to shape the region of the structural part.

When, for example, shaping a wall section of a hollow structural part, such as an extruded profile, the structural part is first clamped in the fixed mounting, and then the region to be shaped is momentarily, i.e. for a maximum of one minute, heated by an induction coil which can be moved across the structural part to approach the region or pivoted towards the region. The forming tool which can be moved in any direction and has a configuration that is suited to the contour of the desired shaping of the structural part, is moved, after the heat application for a time period of maximum 1 minute, through the induction coil which is positioned above the heated region of the structural part for subsequent shaping in the desired manner. The forming tool is then removed again, the structural part is released and then moved in relation to the fixed mounting far enough to allow a shaping of a further region of the structural part and repetition of the cycle. Heating by the induction coil may be carried out continuously or in pulsed mode.

Of course, several, optionally differently designed, induction coils may be used to locally heat several regions of the structural part simultaneously and to then shape them. This requires also respective configuration of the forming tool.

After the region of the structural part has been locally heated, the induction coil can also be moved away from the heated region to then enable the forming tool to shape the region.

When the induction coil has a ring-shaped configuration (circular or polygonal) and/or has a forked configuration for example, the heat flow in the structural part can be used in a targeted way to heat the region to be shaped. The configuration of the induction coil(s) can be suited to the forming tool.

Using such induction coils allows to locally heat any region of, for example, a hollow extruded profile with at least one inner longitudinal wall and/or laterally projecting flanges and then to shape it.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic top and side perspective illustration of one embodiment of an apparatus for shaping a structural part; and

FIG. 2 is a schematic top and side perspective illustration of another embodiment of an apparatus for shaping a structural part.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

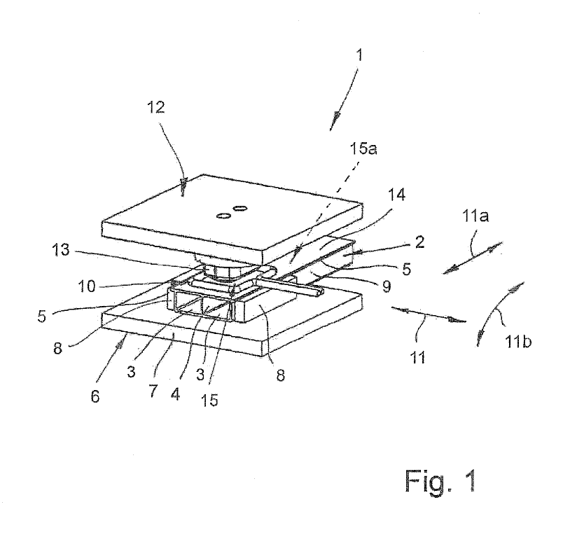

Turning now to the drawing, and in particular to FIG. 1, there is shown a schematic top and side perspective illustration of one embodiment of an apparatus, generally designated by reference numeral 1, for shaping a structural part 2. In the illustrated non-limiting example, the structural part 2 is a hollow extruded profile made of high-strength precipitation-hardened aluminum alloy.

The structural part 2 has two longitudinal channels 3 which are separated by a longitudinal wall 4, two longitudinal sidewalls 9, and two flanges 5 which project laterally beyond the two sidewalls 9 of the structural part 2.

The apparatus 1 includes a mounting 6 for locally securing the structural part 2. The mounting 6 includes a base plate 7 and jaws 8 which are movable across the base plate 7. The apparatus 1 further includes an induction coil 10 which is shown here by way of example in the form of a rectangular configuration and is transversely movable in a direction of double arrow 11. A further component of the apparatus 1 is a forming tool 12 which is vertically adjustable and includes a forming die 13 to produce embossments, not shown in detail, along a broadside 14 of the structural part 2.

After placing the structural part 2 in the mounting 6 and securing the structural part 2 by the jaws 8, the induction coil 10 of the elevated forming tool 12 is moved towards a region 15 of the structural part which is to be locally heated. The region 15 is then heated by the induction coil 10 in pulsed mode to a temperature between 100° C. and 300° C. for a time period of maximal 1 minute. If need be, at least one portion of a flange 5 may hereby be heated as well. Thereafter, the forming tool 12 is moved in a direction of the structural part 2 to enable the forming die 13 to provide the structural part 2 with a desired embossment. The induction coil 10 remains fixed in place during this step, e.g. the forming die 13 travels through the induction coil 10. No heating by the induction coil 10 takes place during the shaping operation.

When the embossing step is over, the jaws 8 of the mounting 6 are released and the structural part 2, while the forming tool 12 has assumed the upper starting position, can now be moved until a next region 15a of the structural part 2 is properly positioned. The structural part 2 is again clamped by the jaws 8 and secured in the mounting 6 for heating of the region 15 and subsequently formation of another embossment.

This mode of operation can be modified after the structural part 15, 15a underwent the heating process by moving the induction coil 10 in a direction of double arrow 11, double arrow 11a, or double arrow 11b, away from the active zone of the forming tool, and then shaping the structural part 2 by the forming tool 12 in the desired manner.

The apparatus 1 may also include several induction coils 10 for heating a corresponding number of regions 15, 15a, etc. of the structural part 2. The forming tool 12 is then provided with a corresponding number of forming dies 13 which, optionally, may be configured differently so as to produce differently configured embossments on the broadside 14, inner longitudinal wall 4, and/or flanges 5 of the structural part 2.

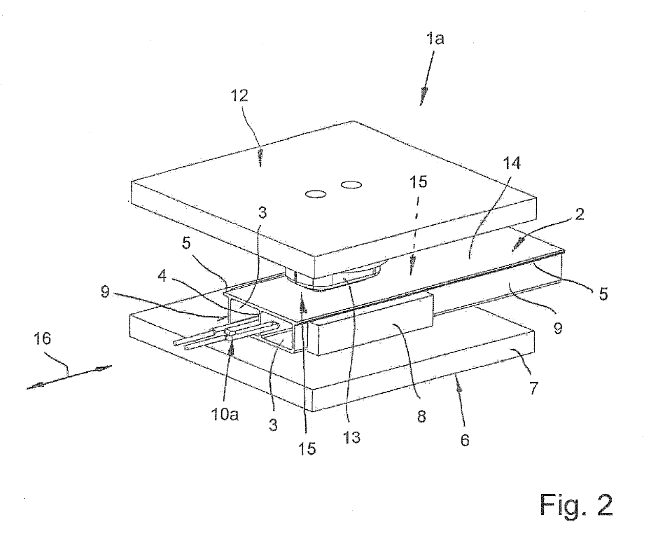

FIG. 2 shows a schematic top and side perspective illustration of another embodiment of an apparatus, generally designated by reference numeral 1a, for shaping a structural part 2. Parts corresponding with those in FIG. 1 are denoted by identical reference numerals and not explained again. The description below will center on the differences between the embodiments. In this embodiment, provision is made for an inductor coil 10a which has a forked configuration. The forked induction coil 10a can hereby be used, by way of example, to locally heat the inner longitudinal wall 4 of structural part 2, i.e. an end of the longitudinal wall 4. This measure may, for example, be carried out when locally shaping a structural part 2 in the form of an extruded profile. The structural part 2 is hereby locally embossed for attachment of a tow lug. For this purpose, the induction coil 10a is moved in a direction of double arrow 16 towards the structural part 2, while embracing the longitudinal wall 4. After heating, the induction coil 10a is again removed in this direction.

While the invention has been illustrated and described in connection with currently preferred embodiments shown and described in detail, it is not intended to be limited to the details shown since various modifications and structural changes may be made without departing in any way from the spirit and scope of the present invention. For example, the induction coils 10, 10a may be used simultaneously for heating the respective regions 15, 5, 4 of the structural part. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method, comprising the steps of:
inductively heating a region of a structural part made of a precipitation-hardened aluminum alloy to a temperature between 100° C. and 300° C. for a maximum of 1 minute; and
mechanically shaping the region.

2. The method of claim 1, wherein the heating step is executed in pulsed mode.

3. The method of claim 1, wherein the region of the structural part is heated by an induction coil.

4. The method of claim 3, wherein the induction coil has a contour which is suited to a contour of the region of the structural part.

5. The method of claim 1, wherein the induction coil has a ring-shaped configuration.

6. The method of claim 5, wherein the shaping step is executed by a forming die which is part of a forming tool and movable through the induction coil.

7. The method of claim 1, wherein the induction coil has a fork-shaped configuration.

8. The method of claim 3, wherein the shaping step is executed by a forming tool which is moved towards the region of the structural part after the region underwent the heating step and the induction coil has been removed from the region of the structural part.

9. The method of claim 1, wherein the structural part is transferred to undergo further shaping steps after the region of the structural part has been heated and mechanically shaped.

10. Apparatus, comprising:
a mounting to secure a structural part;
an induction coil for placement on the structural part to heat a region of the structural part; and
a forming tool movable in a direction towards the structural part to position the forming tool in relation to the structural part and to shape the region of the structural part.

11. The apparatus of claim 10, wherein the forming tool is movable in a direction transversely and vertically to the structural part.

12. The apparatus of claim 10, wherein the induction coil has a ring-shaped configuration.

13. The apparatus of claim 10, wherein the induction coil has a fork-shaped configuration.

14. The apparatus of claim 10, wherein the structural part is made of a precipitation-hardened aluminum alloy.

15. The apparatus of claim 10, wherein the induction coil is configured to heat the region of the structural part to a temperature between 100° C. and 300° C. for a maximum of 1 minute.
